(19) United States
(12) Patent Application Publication
(10) Pub. No.: US 2017/0357236 A1
(43) Pub. Date: Dec. 14, 2017

(54) MANAGING ENVIRONMENTAL EXPOSURE TO COMBUSTION PRODUCTS

(71) Applicant: Elwha LLC, Bellevue, WA (US)

(72) Inventors: ALISTAIR K. CHAN, BAINBRIDGE ISLAND, WA (US); TOM DRISCOLL, SAN DIEGO, CA (US); WILLIAM DAVID DUNCAN, SAMMAMISH, WA (US); W. DANIEL HILLIS, CAMBRIDGE, MA (US); RODERICK A. HYDE, REDMOND, WA (US); MURIEL Y. ISHIKAWA, LIVERMORE, CA (US); CLARENCE T. TEGREENE, MERCER ISLAND, WA (US); CHARLES WHITMER, NORTH BEND, WA (US); LOWELL L. WOOD, JR., BELLEVUE, WA (US); VICTORIA Y.H. WOOD, LIVERMORE, CA (US)

(21) Appl. No.: 15/177,565

(22) Filed: Jun. 9, 2016

(51) Int. Cl. G05B 19/10; H04W 4/20; H04W 4/00; H04L 12/26

(52) U.S. Cl. CPC G05B 19/10; H04L 43/065; H04W 4/20; H04W 4/005; G05B 2219/2623

(57) ABSTRACT

Described embodiments include a system and a method. The system includes a sensor device configured to measure a combustion product in an exhaust stream generated by a fossil-fueled combustion apparatus. The system includes a combustion analysis circuit configured to generate air pollution information responsive to (i) the measured combustion product and (ii) an emission target for the measured combustion product. The system includes a user interface configured to display the air pollution information in a human perceivable format. In an embodiment, the system includes a combustion controller configured to regulate an aspect of the combustion of the fossil fuel in response to the air quality management selection entered by the human user.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

NONE

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

For example, and without limitation, an embodiment of the subject matter described herein includes a system. The system includes a sensor device configured to measure a combustion product in an exhaust stream generated by a fossil-fueled combustion apparatus. The system includes a combustion analysis circuit configured to generate air pollution information responsive to (i) the measured combustion product and (ii) an emission target for the measured combustion product. The system includes a user interface configured to display the air pollution information in a human perceivable format. In an embodiment, the system includes a combustion controller configured to regulate an aspect of the combustion of the fossil fuel in response to the air quality management selection entered by the human user.

For example, and without limitation, an embodiment of the subject matter described herein includes a method. The method includes measuring a combustion product in an exhaust stream generated by a fossil-fueled combustion apparatus. The method includes generating an air pollution information responsive to (i) the measured combustion product and (ii) an emission target for the measured combustion product. The method includes displaying the air pollution information in a human perceivable format.

In an embodiment, the method includes receiving an air quality management selection entered by a human user. In an embodiment, the method includes regulating an aspect of combustion air delivered to the fossil-fueled combustion apparatus in response to the air quality management selection entered by the human user.

For example, and without limitation, an embodiment of the subject matter described herein includes a system. The system includes a sensor device configured to measure a combustion product in an exhaust stream generated by a fossil-fueled combustion apparatus. The system includes a combustion analysis circuit configured to generate air pollution information responsive to the measured combustion product. The system includes an output circuit configured to transmit a signal indicative of the air pollution information in a format usable by a computing device.

In an embodiment, the system includes a credit receiver circuit configured to receive from a remote computing device an indication of a credit or reward responsive to the air pollution information. In an embodiment, the system includes a selection receiver circuit configured to receive from the consumer-accessible platform an air quality management selection entered by a human user. In an embodiment, the system includes a combustion controller configured to regulate an aspect of combustion of the fossil fuel in response to the air quality management selection entered by the human user.

For example, and without limitation, an embodiment of the subject matter described herein includes a method. The method includes measuring a combustion product in an exhaust stream generated by a fossil-fueled combustion apparatus. The method includes generating a pollution information responsive to (i) the measured combustion product and (ii) an emission target for the measured combustion product. The method includes transmitting a signal indicative of the air pollution information in a format usable by a computing device.

In an embodiment, the method includes receiving from a consumer-accessible platform an air quality management selection entered by a human user. In an embodiment, the method includes regulating an aspect of combustion of the fossil fuel in response to the air quality management selection entered by the human user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example environment in which embodiments may be implemented;

FIG. 2 illustrates an example operational flow in which embodiments may be implemented;

FIG. 3 illustrates an environment in which embodiments may be implemented;

FIG. 4 illustrates an environment in which embodiments may be implemented;

FIG. 5 illustrates an example operational flow in which embodiments may be implemented;

FIG. 6 illustrates an environment in which embodiments may be implemented; and

FIG. 7 illustrates an example operational flow in which embodiments may be implemented.

### DETAILED DESCRIPTION

This application makes reference to technologies described more fully in U.S. patent application Ser. No. ______, MANAGING ENVIRONMENTAL EXPOSURE TO COMBUSTION PRODUCTS, naming Alistair K. Chan, Tom Driscoll, William David Duncan, W. Daniel Hillis, Roderick A. Hyde, Muriel Y. Ishikawa, Clarence T. Tegreene, Charles Whitmer, Lowell L. Wood, Jr., and Victoria Y. H. Wood, filed on Jun. 9, 2016, is related to the present application. That application is incorporated by reference herein, including any subject matter included by reference in that application.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “circuitry” and “electrical circuitry” both include, but are not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch-sensitive screen or display surface, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch-sensitive screen or display surface, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

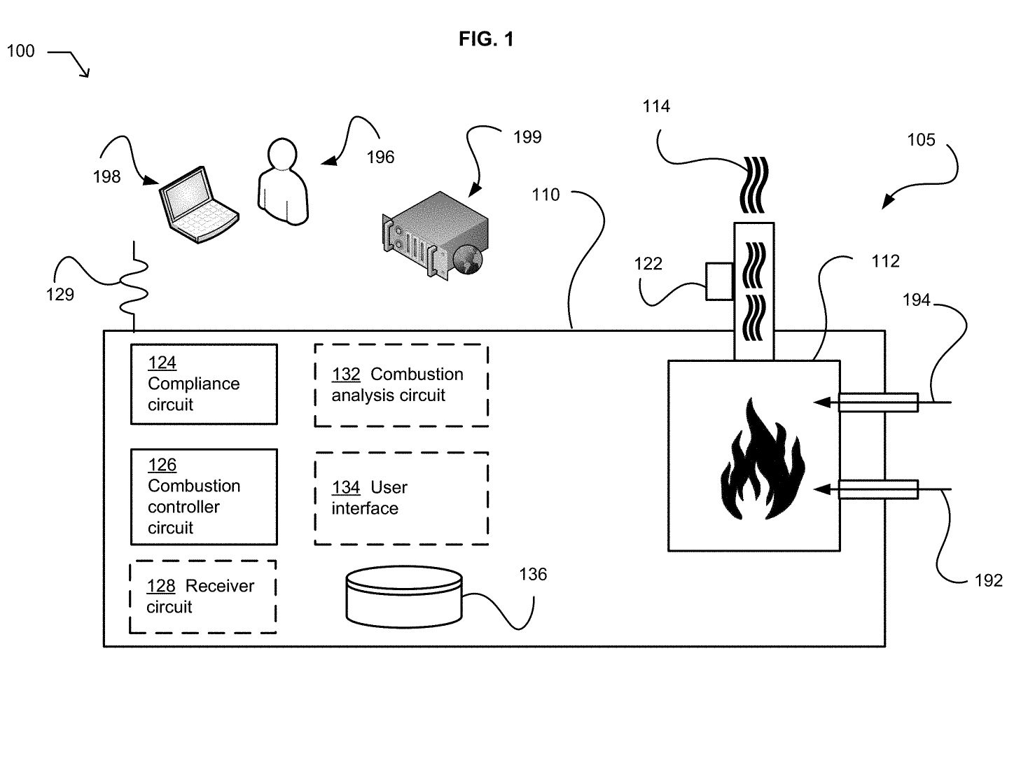

FIG. 1 illustrates an example environment 100 in which embodiments may be implemented. The environment includes a fossil-fueled combustion apparatus 105 having a burner 112 and a system 110. The system includes a sensor device 122 configured to measure a combustion product in an exhaust stream 114 from the fossil-fueled combustion apparatus. In an embodiment, the fossil fuel 192 includes a gas, oil, kerosene, coal, propane, or wood fossil fuel. In an embodiment, the fossil-fueled combustion device includes a heat producing apparatus with combustion occurring in an open combustion burner or a closed combustion burner with a relatively constant volume. In an embodiment, the fossil-fueled combustion device includes a stationary fossil-fueled combustion device. The fossil-fueled combustion device does not include an engine where combustion takes place in a closed expansible volume or chamber structure, generally a cylinder, and the hot combustion gasses are used to drive a piston or a gas turbine to do work or provide motive power. The fossil-fueled combustion device does not include an internal combustion engine. In an embodiment, the burner is a single burner. In an embodiment, the burner includes at least two burners. In an embodiment, the sensor device may be positioned to measure the combustion product from a portion of exhaust stream in an open or free space proximate to a flue of the gas-fueled combustion apparatus. The system includes a compliance circuit 124 configured to generate an air quality management signal responsive to the measured combustion product and an emission target for the measured combustion product. In an embodiment, the target value of the combustion product may be a selected target value. For example the target value may be selected by a consumer, owner, or operator of the fossil-fueled combustion apparatus. In an embodiment, the target value of the combustion product may be specified by a manufacturer of the fossil-fueled combustion apparatus. In an embodiment, the target value of the combustion product may be specified by a governmental or regulatory authority. In an embodiment, the target value may be suggested or recommended by an industry association. The system includes a combustion controller circuit 126 configured to regulate an aspect of the combustion of the fossil fuel in response to the air quality management signal. In an embodiment, the regulation is configured to change the emitted combustion product toward a compliance with the emission target.

In an embodiment of the system 100, the combustion apparatus 105 includes a household combustion apparatus. For example, the household combustion apparatus may include a stove, oven, gas grill, fireplace, or candle. In an embodiment, the combustion apparatus includes a water heater, dryer, stove top, grill, or oven. In an embodiment, the combustion apparatus includes a household appliance. In an embodiment, the combustion apparatus includes a commercial appliance. In an embodiment, the combustion apparatus includes an industrial fossil-fueled combustion apparatus. In an embodiment, the combustion apparatus includes an open flame combustion apparatus. In an embodiment, the combustion apparatus includes a contained flame combustion appliance. For example, a contained flame combustion appliance may include a furnace with an enclosed structure in which heat is produced. In an embodiment, the combustion apparatus includes a constant volume combustion apparatus. In an embodiment, the combustion product includes carbon dioxide, carbon monoxide, sulfur dioxide, nitrogen oxides, lead, hydrogen cyanide, or particulate matter. In an embodiment, the combustion product includes an unburned portion of a fossil fuel burned by the combustion apparatus. For example, the unburned portion may include unburned wood, methane, natural gas, ethane, butane, or a propane component. In an embodiment, the combustion product includes a hazardous combustion product. In an embodiment, the combustion product includes a combustion product harmful to humans or animals. In an embodiment, the combustion product includes an indicator of a harmful combustion product. In an embodiment, the combustion product includes a combustion reaction product. In an embodiment, the combustion product includes a greenhouse-effect gas. For example, a greenhouse-effect gas may include carbon dioxide, unburnt fuel components such as methane.

In an embodiment, the sensor device 122 includes a sensor device configured to optically measure the combustion product in the exhaust stream 114. In an embodiment, the sensor device includes a sensor device configured to optically measure light emitted by molecules of the combustion product. In an embodiment, the sensor device includes a sensor device configured to beam a light into the exhaust stream causing a fluorescence of gas molecules in the exhaust stream, detect the fluorescence of the gas molecules in the exhaust stream, and measure a combustion product in response to the detected fluorescence of the gas molecules. In an embodiment, the sensor device includes a sensor device configured to beam an ionic radiation or electron radiation into the exhaust stream causing a fluorescence of gas molecules in the exhaust stream, detect the fluorescence of the gas molecules, and measure a combustion product in response to the detected fluorescence of the gas molecules. In an embodiment, the sensor device includes a sensor device configured to beam a light through the exhaust stream, detect an absorption or scattering of the beamed light by gas molecules in the exhaust stream, and measure a combustion product in response to the detected absorption or scattering by the gas molecules.

In an embodiment of the compliance circuit 124, the emission target includes an instantaneous, average, or cumulative emission target for the measured combustion product. For example, the emission target may take into account a duration of a combustion. For example, a short cooking task may be allowed a high emission level because the cooking time will be short. In an embodiment, the emission target includes a time-of-day based emission target for the measured combustion product. In an embodiment, the emission target is responsive to a rate-of-change in the measured combustion product in the exhaust stream. In an embodiment, the emission target is at least partially based on measured historical emissions of the combustion product in the exhaust stream from the fossil-fueled combustion apparatus 105. For example, the historical emissions may include a measured historical hourly, daily, weekly, or yearly historical emission level. In an embodiment, the emission target is at least partially based on estimated historical emissions of the combustion product in the exhaust stream from the fossil-fueled combustion apparatus. For example, the estimated historical emissions may include a estimated hourly, daily, weekly, or yearly emission level. In an embodiment, the emission target is at least partially based on projected emissions of the combustion product in the exhaust stream from the fossil-fueled combustion apparatus. For example, the estimated historical emissions may include a projected hourly, daily, weekly, or yearly emission level. For example, a estimated value may be based on an expected usage duration. In an embodiment, the emission target is at least partially based on an industry or governmental standard. For example, a governmental standard may include a federal, state, regional, or local governmental standard. In an embodiment, the emission target is at least partially based on a current or forecasted air quality status or condition. For example, a large metropolitan area such as Los Angeles may report a current air quality status or condition. For example, a large metropolitan area may forecast an air quality status or condition. For example, in response, the emission target may be reduced during a current or forecast high air pollution event, such as smog. For example, the emission target may be increased allowing more emissions during an existing or a forecasted absence of significant air pollution. In an embodiment, the emission target is at least partially based on a location of the system. For example, the location of the system may include a specific city, county, state, or country. For example, the location of the system may include a population density of a location of the system. For example, a population density may include a characterization of the location as rural or urban. In an embodiment, the emission target is at least partially based on whether the system is at a fixed location or carried by a mobile vehicle. For example, a mobile vehicle may include a camper or recreational vehicle.

In an embodiment, the system 110 includes a receiver circuit 128 configured to receive a current or forecasted air quality status or condition. For example, the receiver circuit may receive the current or forecasted air quality status or condition from a local network or the Internet. For example, the receiver circuit may receive the information wirelessly 129 or via a wired connection.

In an embodiment of the compliance circuit 124, the air quality management signal includes a specified fossil fuel 192 to combustion air 194 ratio responsive to the measured combustion product. In an embodiment, the air quality management signal includes a specified combustion air feed rate responsive to the measured combustion product. In an embodiment, the air quality management signal includes a selected combustion air feed location. For example, the selected combustion air feed location may be relative to a fossil-fuel feed location. For example, the selected combustion air feed location may be relative to a flame temperature. For example, the selected combustion air feed location may include injecting the combustion air into a hotter or a colder region of a combustion flame. For example, the selected combustion air feed location may include injecting the combustion air into a center or a borders of a combustion flame. In an embodiment, the air quality management signal includes a specified fossil-fuel feed velocity. In an embodiment, the air quality management signal includes a selected fossil-fuel feed location. In an embodiment, the air quality management signal includes a specified fossil-fuel flow volume to the burner responsive to the measured combustion product. In an embodiment, the compliance circuit is configured to generate an air quality management signal responsive to (i) the measured combustion product in the exhaust stream, (ii) an emission target value for the measured combustion product, and (iii) a combustion reaction product in the exhaust stream. In an embodiment, the compliance circuit is configured to generate an air quality management signal responsive to (i) the measured combustion product and (ii) an emission target for the measured combustion product only if the measured combustion product exceeds a threshold. In an embodiment, the compliance circuit is configured to generate an air quality management signal responsive to (i) the measured combustion product and (ii) an emission target for the measured combustion product only if the measured combustion product exceeds a cumulative threshold. In an embodiment, the compliance circuit is configured to generate an air quality management signal responsive to (i) the measured combustion product and (ii) an emission target for the measured combustion product, and that maintain the level of the measured combustion product below the emission target for the measured combustion product.

In an embodiment, the combustion controller circuit 126 is configured to regulate the fossil fuel 192 fed to the combustion apparatus in response to the air quality management signal. For example, the combustion controller may regulate a type of fossil fuel or a composition of fossil fuel fed to the combustion apparatus. In an embodiment, the combustion controller circuit is configured to regulate the combustion air 194 fed to the combustion apparatus 105 in response to the air quality management signal. For example, the combustion air may include ambient air, natural air, nitrogen-depleted air, or oxygen. In an embodiment, the combustion controller is configured to regulate the fuel-combustion air mixing. For example, the combustion controller may be configured to regulate a size of fuel droplets, or a local fuel/air ration.

In an embodiment, the system 110 includes a combustion analysis circuit 132 configured to generate an air pollution information responsive to the measured combustion product. In an embodiment, the combustion analysis circuit is configured to generate the air pollution information responsive to (i) the measured combustion product and (ii) the emission target for the measured combustion product.

In an embodiment, the system 110 includes a user interface 134 configured to display the air pollution information in a human 196 perceivable format. In an embodiment, the combustion analysis circuit 132 is configured to output a signal indicative of the air pollution information in a format usable by a consumer-accessible platform 198. In an embodiment, the consumer-accessible platform includes a mobile consumer-accessible platform. The consumer is illustrated as consumer 196. In an embodiment, the consumer-accessible platform includes a smart phone, a tablet, a laptop computer, or a mobile device. In an embodiment, the consumer-accessible platform includes a web enabled device. In an embodiment, the consumer-accessible platform includes a cellular mobile device. In an embodiment, the consumer-accessible platform includes an application configured to display or share the quality of combustion information. In an embodiment, the combustion analysis circuit is configured to output a signal indicative of the air pollution information to a remote computing device 199. For example, the remote computing device may include a central air pollution monitoring system or a pollution credit management system. For example, the remote computing device may communicate with the system 110 via a network or the Internet using a wireless or a wired connectivity.

In an embodiment, the compliance circuit 124 is configured to generate an air quality management signal responsive to (i) a measured combustion product in the exhaust stream, (ii) an emission target value for the measured combustion product, and (iii) stored data indicative of cumulative emissions of the measured combustion product by the combustion apparatus in the exhaust stream. In an embodiment, the compliance circuit is configured to generate an air quality management signal responsive to (i) a measured combustion product in the exhaust stream, (ii) an emission target value for the measured combustion product, and (iii) correlations between the combustion parameters and emissions of the measured combustion product for the combustion apparatus.

In an embodiment, the system 110 includes a non-transitory computer readable storage media 136 configured to store data indicative of cumulative emissions of the measured combustion product by the combustion apparatus, or correlations between the combustion parameters and emissions of the measured combustion product for the combustion apparatus 105. For example, the storage media may be physically associated with the system 110. For example, the storage media may be remotely located and accessible via a network to the compliance circuit 124. For example, in the remote storage media, the data may be tagged with an ID for the combustion apparatus, or for respectively tagged for each burner of the combustion apparatus.

FIG. 1 also illustrates another embodiment of the fossil-fueled combustion apparatus 105 and the system 110. In this embodiment, the fossil-fueled combustion apparatus includes at least two burners 112. The system includes the sensor device 122 configured to measure a combustion product in each respective exhaust stream of at least two burners of a fossil-fueled combustion apparatus. The system includes the compliance circuit 124 configured to generate for each burner of the at least two burners a respective air quality management signal. Each air quality management signal is responsive to the measured combustion product in the exhaust stream of the respective burner and an emission target for the measured combustion product in the exhaust stream of the respective burner. The system includes the combustion controller circuit 126 configured to regulate an aspect of the combustion of the fossil fuel of each burner of the at least two burners in response to their respective air quality management signals.

In an embodiment, the compliance circuit 124 is configured to generate for each burner of the at least two burners 112 a respective air quality management signal responsive to (i) the measured combustion product and (ii) an emission target for the measured combustion product. The respective air quality management signals in combination maintain the level of the measured combustion product in the exhaust stream below an emission target for the fossil-fueled combustion apparatus. For example, in a multi-burner stove or grill, the emission measurements can be correlated with which burners are being used. For example, one burner may historically tend to emit more of an undesirable combustion product, and that burner may be operated at a reduced output.

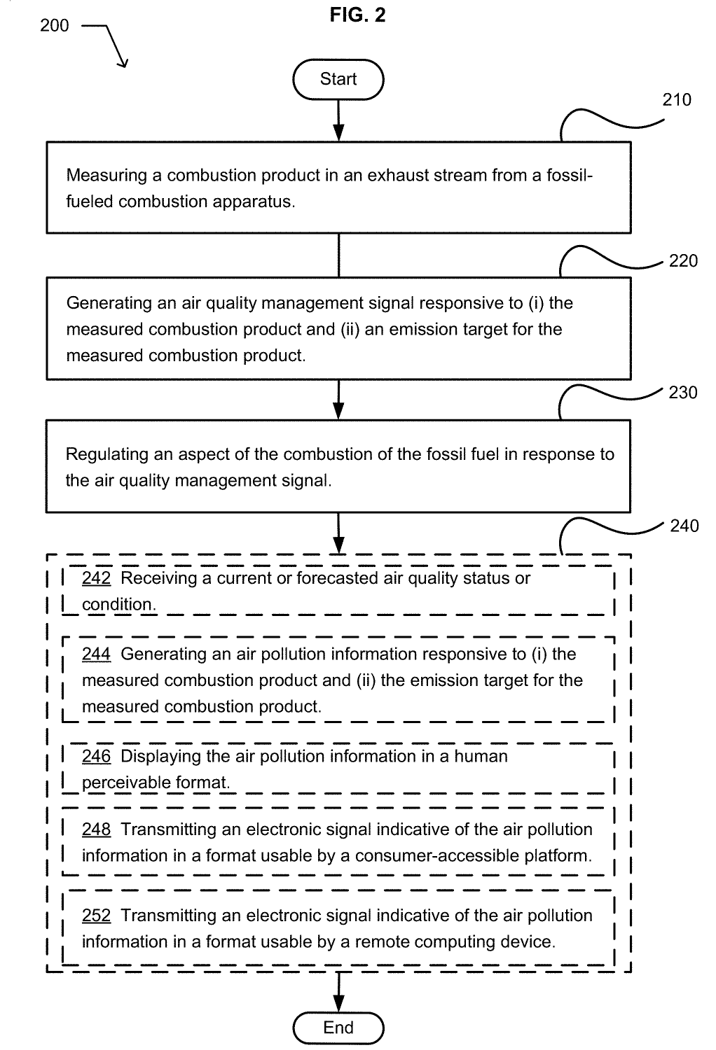

FIG. 2 illustrates an example operational flow 200 in which embodiments may be implemented. After a start operation, the operational flow includes sensing operation 210. The sensing operation includes measuring a combustion product in an exhaust stream from a fossil-fueled combustion apparatus. In an embodiment, the sensing operation may be implemented using the sensor device 112 described in conjunction with FIG. 1. An analysis operation 220 includes generating an air quality management signal responsive to (i) the measured combustion product and (ii) an emission target for the measured combustion product. In an embodiment, the analysis operation may be implemented using the compliance circuit 124 described in conjunction with FIG. 1. A control operation 230 includes regulating an aspect of the combustion of the fossil fuel in response to the air quality management signal. In an embodiment, the control operation may be implemented using the combustion controller 126 described in conjunction with FIG. 1. The operational flow includes an end operation.

In an embodiment, the operational flow 200 may include at least one additional operation 240. In an embodiment, the at least one additional operation includes receiving 242 a current or forecasted air quality status or condition. In an embodiment, the emission target is at least partially based on the received current or forecasted air quality status or condition. In an embodiment, the at least one additional operation includes generating 244 an air pollution information responsive to (i) the measured combustion product and (ii) the emission target for the measured combustion product. In an embodiment, the at least one additional operation includes displaying 246 the air pollution information in a human perceivable format. In an embodiment, the at least one additional operation includes transmitting 248 an electronic signal indicative of the air pollution information in a format usable by a consumer-accessible platform. In an embodiment, the at least one additional operation includes transmitting 252 an electronic signal indicative of the air pollution information in a format usable by a remote computing device.

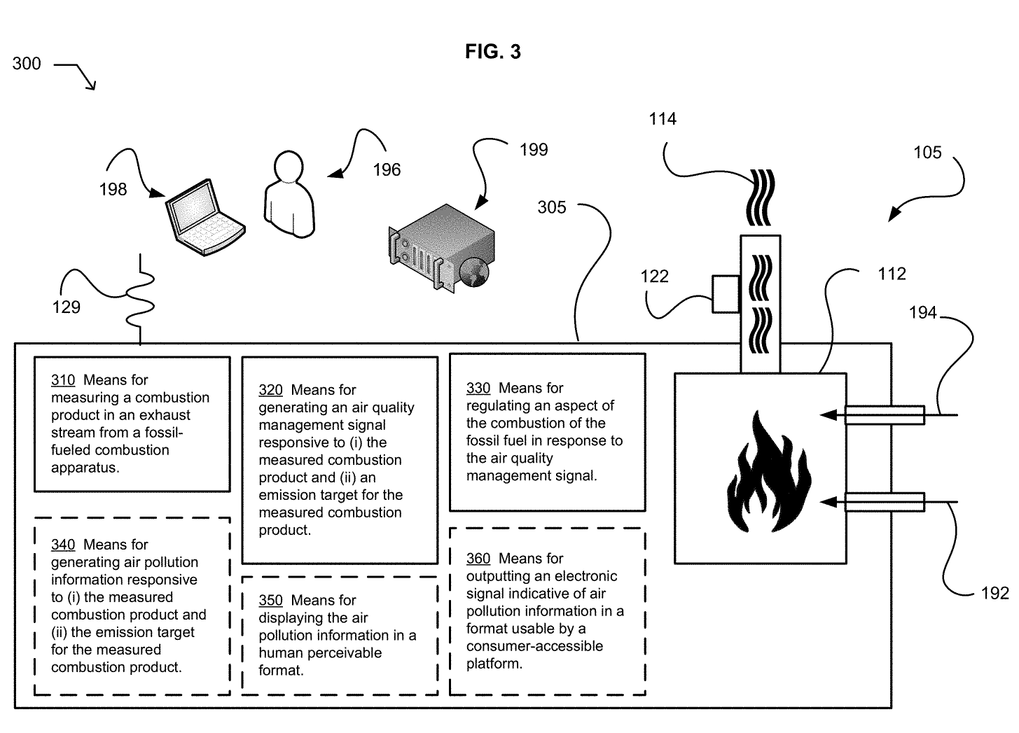

FIG. 3 illustrates an environment 300 in which embodiments may be implemented. The environment includes the fossil-fueled combustion apparatus 105 having the burner 112 and a system 305. The system includes means 310 for measuring a combustion product in the exhaust stream 114 from the fossil-fueled combustion apparatus. The system includes means 320 for generating an air quality management signal responsive to (i) the measured combustion product and (ii) an emission target for the measured combustion product. The system includes means 330 for regulating an aspect of the combustion of the fossil fuel in response to the air quality management signal.

In an embodiment, the system 305 includes means 340 for generating air pollution information responsive to (i) the measured combustion product and (ii) the emission target for the measured combustion product. In an embodiment, the system includes means 350 for displaying the air pollution information in a human perceivable format. In an embodiment, the system includes means 360 for outputting an electronic signal indicative of air pollution information in a format usable by a consumer-accessible platform.

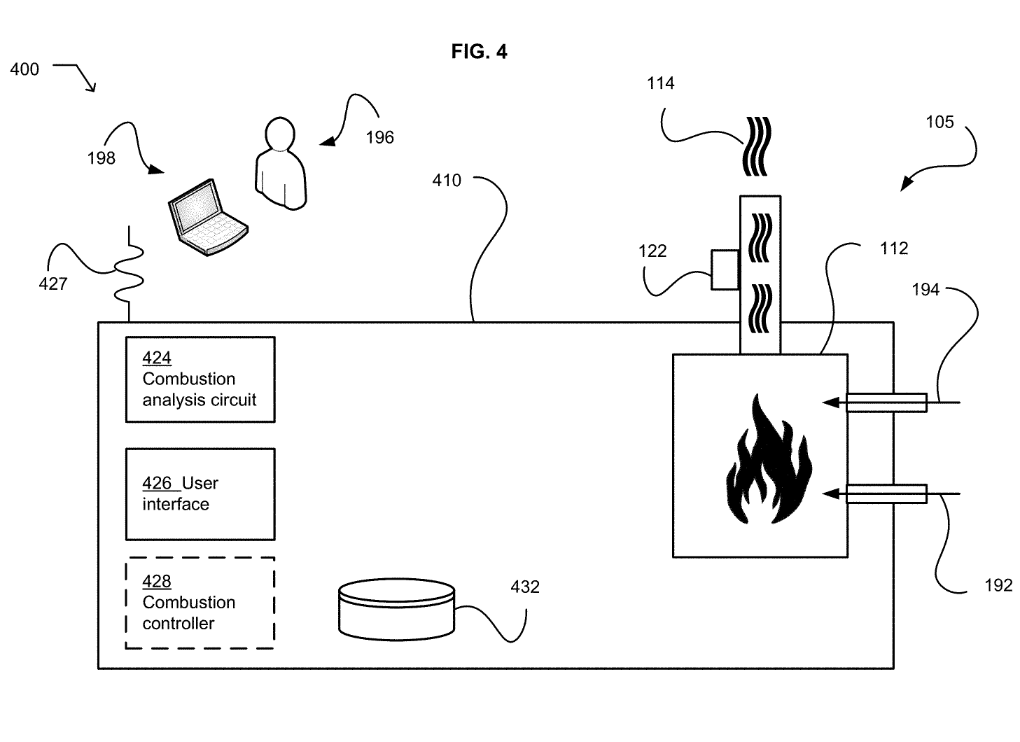

FIG. 4 illustrates an environment 400 in which embodiments may be implemented. The environment includes the fossil-fueled combustion apparatus 105 having the burner 112 and a system 410. The system includes the sensor device 122 configured to measure a combustion product in the exhaust stream 114 generated by the fossil-fueled combustion apparatus. The system includes a combustion analysis circuit 424 configured to generate air pollution information responsive to (i) the measured combustion product and (ii) an emission target for the measured combustion product. The system includes a user interface 426 configured to display the air pollution information in a human perceivable format.

In an embodiment, the sensor device 122 includes a sensor device configured to optically measure a combustion product in the exhaust stream 114. In an embodiment, the sensor device is further configured to measure a combustion reaction product in the exhaust stream.

In an embodiment of the combustion analysis circuit 424, the air pollution information includes an indication of a level or quantification of the measured combustion product in the exhaust stream 114. In an embodiment, the air pollution information includes an indication of a savings of fossil-fuel. For example, the fossil-fuel savings may be expressed as an annualized or cumulative savings. For example, the fossil-fuel savings may be expressed relative to a selected time period. In an embodiment, the air pollution information includes an indication of a greenhouse gas effect of the measured combustion product in the exhaust stream. In an embodiment, the air pollution information includes a rate of production of the measured combustion product. In an embodiment, the air pollution information includes a comparison of a rate of production of the measured combustion product to the target rate. In an embodiment, the air pollution information includes a comparison of a rate production of the measured combustion product to a specified metric. In an embodiment, the air pollution information includes a projected production of the measured combustion product over a specified time interval. In an embodiment, the air pollution information includes a comparison of greenhouse gas effects of the measured combustion product relative to that of CO2 components in the exhaust stream.

In an embodiment, the user interface 426 is further configured to receive an air quality management selection entered by a human user, illustrated as the human user 196. For example, the air quality management selection may be a selected emission level of the combustion product or of a combustion reaction product. In an embodiment, the air quality management selection includes an indication of an affect the air quality management selection in changing the measured combustion product in the exhaust stream. In an embodiment, the system 410 includes a combustion controller 428 configured to regulate an aspect of the combustion of the fossil fuel 192 in response to the air quality management selection entered by the human user.

In an embodiment, the combustion analysis circuit 424 is configured to generate an air pollution information responsive to (i) a measured combustion product in the exhaust stream, (ii) an emission target value for the measured combustion product, and (iii) stored data indicative of cumulative emissions of the measured combustion product by the combustion apparatus in the exhaust stream. In an embodiment, the combustion analysis circuit is configured to generate an air pollution information responsive to (i) a measured combustion product in the exhaust stream, (ii) an emission target value for the measured combustion product, and (iii) correlations between the combustion parameters and emissions of the measured combustion product for the combustion apparatus. In an embodiment, the system 110 includes

In an embodiment, the system 410 includes a non-transitory computer readable storage media 432 configured to store data indicative of cumulative emissions of the measured combustion product by the combustion apparatus, and correlations between the combustion parameters and emissions of the measured combustion product for the combustion apparatus 105. For example, the storage media may be physically associated with the system 410. For example, the storage media may be remotely located and accessible via a network to the combustion analysis circuit 424. For example, in the remote storage media, the data may be tagged with an ID for the combustion apparatus, or for respectively tagged for each burner of the combustion apparatus.

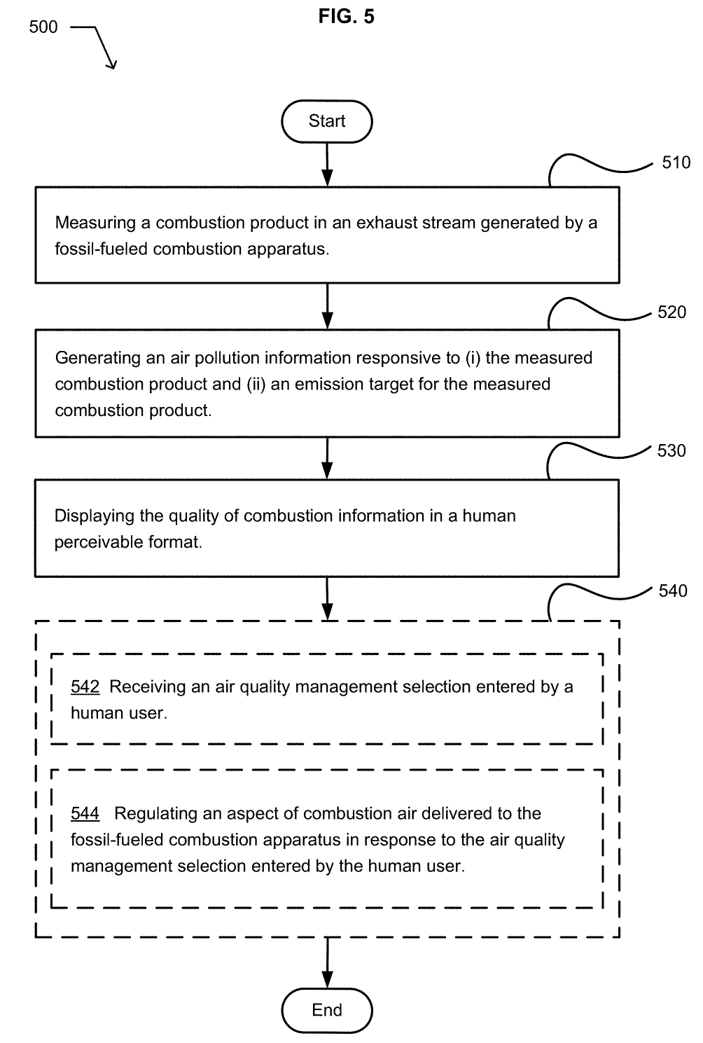

FIG. 5 illustrates an example operational flow 500 in which embodiments may be implemented. After a start operation, the operational flow includes sensing operation 510. The sensing operation includes measuring a combustion product in an exhaust stream generated by a fossil-fueled combustion apparatus. In an embodiment, the sensing operation may be implemented using the sensor 122 described in conjunction with FIG. 4. An analysis operation 520 includes generating an air pollution information responsive to (i) the measured combustion product and (ii) an emission target for the measured combustion product. In an embodiment, the analysis operation may be implemented using the combustion analysis circuit 424 described in conjunction with FIG. 4. A communication operation 530 includes displaying the air pollution information in a human perceivable format. In an embodiment, the communication operation may be implemented using the user interface 426 described in conjunction with FIG. 4. For example, the user interface may include a visual or audio display device configured to display the air pollution information in a human-perceivable format. For example, the human perceivable format may include displaying the air pollution information by the consumer-accessible platform 198. In an embodiment, the consumer-accessible platform includes a mobile consumer-accessible platform. In an embodiment, the consumer-accessible platform includes a smart phone, a tablet, a laptop computer, or a mobile device. In an embodiment, the consumer-accessible platform includes a web enabled device. In an embodiment, the consumer-accessible platform includes a cellular mobile device. In an embodiment, the consumer-accessible platform includes an application configured to display or share the quality of combustion information. The operational flow includes an end operation.

In an embodiment, the operational flow includes at least one additional operation 540. In an embodiment, the at least one additional operation includes receiving 542 an air quality management selection entered by a human user. In an embodiment, the at least one additional operation includes regulating 544 an aspect of combustion air delivered to the fossil-fueled combustion apparatus in response to the air quality management selection entered by the human user.

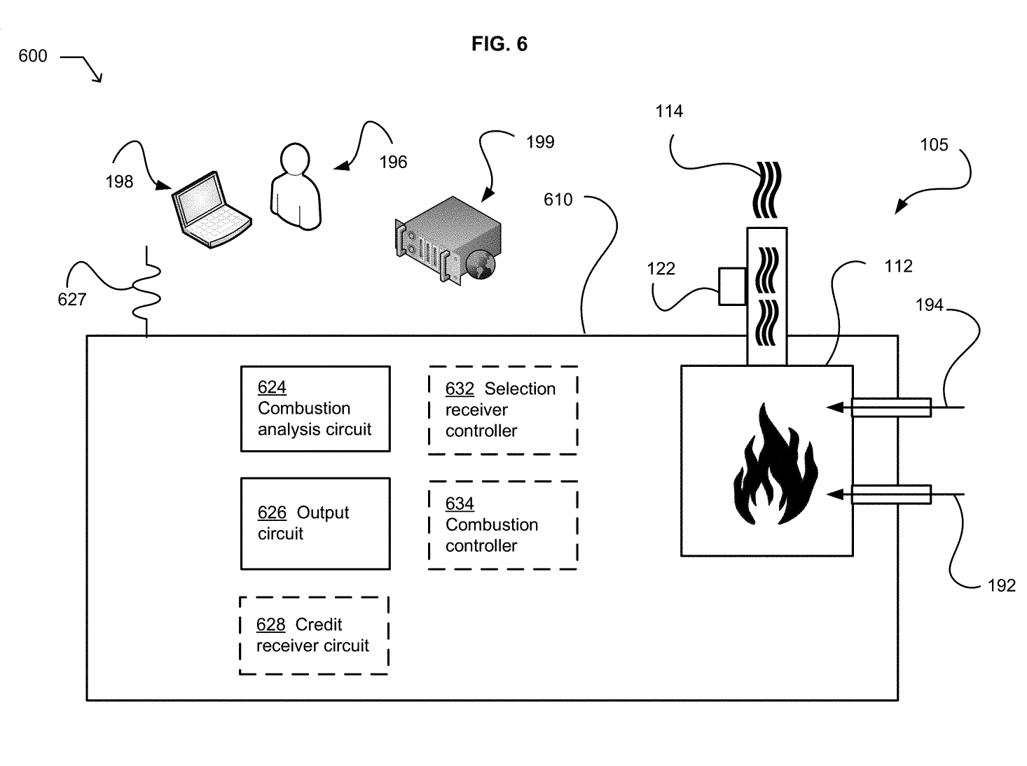

FIG. 6 illustrates an environment 600 in which embodiments may be implemented. The environment includes a fossil-fueled combustion apparatus 105 having the burner 112 and a system 610. The system includes the sensor device 122 configured to measure a combustion product in the exhaust stream 114 generated by the fossil-fueled combustion apparatus. The system includes a combustion analysis circuit 624 configured to generate an air pollution information responsive to the measured combustion product. The system includes an output circuit 626 configured to transmit a signal indicative of the air pollution information in a format usable by a computing device. An embodiment of the computing device is illustrated by the consumer-accessible platform 198. An embodiment of the computing device is illustrated by the remote computing device 199. In an embodiment, the combustion analysis circuit 624 is configured to generate air pollution information responsive to (i) the measured combustion product and (ii) an emission target for the measured combustion product.

In an embodiment, the output circuit 626 is configured to transmit signal indicative of the air pollution information in a format usable by the consumer-accessible platform 196. In an embodiment, the consumer-accessible platform includes a cellular mobile device. In an embodiment, the consumer-accessible platform includes a processor, display, and user input device. In an embodiment, the consumer-accessible platform includes a computing device. In an embodiment, the consumer-accessible platform includes a web enabled device. In an embodiment, the computing device includes a remote or networked computing device 199. For example, a remote or networked computing device may include a central air pollution monitoring station linked via a network or the Internet. For example, the output circuit may be configured to transmit signal indicative of the air pollution information wirelessly 627, or via wired connection.

In an embodiment, the system 610 includes a credit receiver circuit 628 configured to receive from a remote or networked computing device an indication of a credit or reward responsive to the air pollution information. In an embodiment, the credit includes a regulatory credit. In an embodiment, the credit includes a financial credit. In an embodiment, the credit includes a token representing a credit. In an embodiment, the credit includes a thing of tangible or intangible value.

In an embodiment, the system 610 includes a selection receiver circuit 632 configured to receive from the consumer-accessible platform 198 an air quality management selection entered by the human user 196. In an embodiment, the system includes a combustion controller 634 configured to regulate an aspect of combustion of the fossil fuel in response to the air quality management selection entered by the human user.

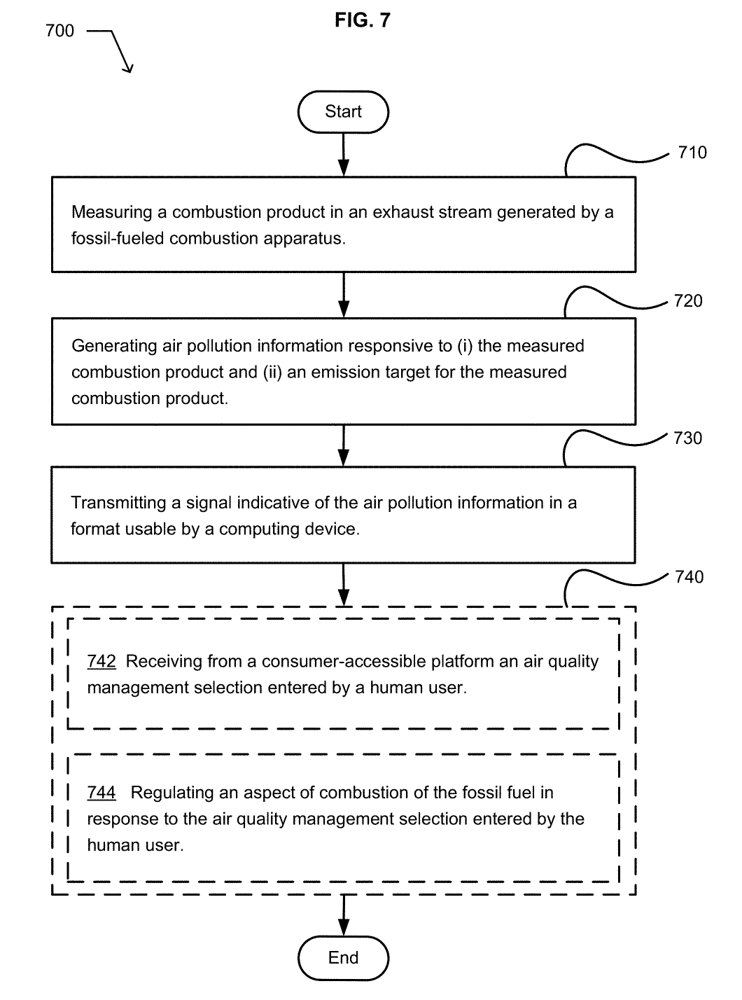

FIG. 7 illustrates an example operational flow 700 in which embodiments may be implemented. After a start operation, the operational flow includes sensing operation 710. The sensing operation includes measuring a combustion product in an exhaust stream generated by a fossil-fueled combustion apparatus. In an embodiment, the sensing operation may be implemented using the sensor 122 described in conjunction with FIG. 6. An analysis operation 720 includes generating air pollution information responsive to (i) the measured combustion product and (ii) an emission target for the measured combustion product. In an embodiment, the analysis operation may be implemented using the combustion analysis circuit 624 described in conjunction with FIG. 6. A communication operation 740 includes transmitting a signal indicative of the air pollution information in a format usable by a computing device. For example, the presentation operation may visually or audibly display the air pollution information in a human perceivable format. In an embodiment, the communication operation may be implemented using the output circuit 626 described in conjunction with FIG. 6. The operational flow includes an end operation.

In an embodiment, the operational flow 700 includes at least one additional operation 740. In an embodiment, the at least one additional operation includes receiving 742 from a consumer-accessible platform an air quality management selection entered by a human user. In an embodiment, the at least one additional operation includes regulating 744 an aspect of combustion of the fossil fuel in response to the air quality management selection entered by the human user.

All references cited herein are hereby incorporated by reference in their entirety or to the extent their subject matter is not otherwise inconsistent herewith.

In some embodiments, “configured” or “configured to” includes at least one of designed, set up, shaped, implemented, constructed, or adapted for at least one of a particular purpose, application, or function. In some embodiments, “configured” or “configured to” includes positioned, oriented, or structured for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
a sensor device configured to measure a combustion product in an exhaust stream generated by a fossil-fueled combustion apparatus;
a combustion analysis circuit configured to generate air pollution information responsive to (i) the measured combustion product and (ii) an emission target for the measured combustion product; and
a user interface configured to display the air pollution information in a human perceivable format.

2. The system of claim 1, wherein the sensor device includes a sensor device configured to optically measure a combustion product in the exhaust stream.

3. The system of claim 1, wherein the sensor device is further configured to measure a combustion reaction product in the exhaust stream.

4. The system of claim 1, wherein the air pollution information includes an indication of a level or quantification of the measured combustion product in the exhaust stream.

5. The system of claim 1, wherein the air pollution information includes an indication of fossil-fuel savings.

6. The system of claim 1, wherein the air pollution information includes an indication of a greenhouse gas effect of the measured combustion product in the exhaust stream.

7. The system of claim 1, wherein the air pollution information includes a rate of production of the measured combustion product.

8. The system of claim 1, wherein the air pollution information includes a comparison of a rate of production of the measured combustion product to the target rate.

9. The system of claim 1, wherein the air pollution information includes a comparison of a rate production of the measured combustion product to a specified metric.

10. The system of claim 1, wherein the air pollution information includes a projected production of the measured combustion product over a specified time interval.

11. The system of claim 1, wherein the air pollution information includes a comparison of greenhouse gas effects of the measured combustion product relative to that of CO2 components in the exhaust stream.

12. The system of claim 1, wherein the user interface is further configured to receive an air quality management selection entered by a human user.

13. The system of claim 12, wherein the quality management selection includes an indication of an effect of the air quality management signal in changing the measured combustion product in the exhaust stream.

14. The system of claim 12, further comprising:
a combustion controller configured to regulate an aspect of the combustion of the fossil fuel in response to the air quality management selection entered by the human user.

15. The system of claim 1, wherein the combustion analysis circuit is configured to generate air pollution information responsive to (i) a measured combustion product in the exhaust stream, (ii) an emission target value for the measured combustion product, and (iii) stored data indicative of cumulative emissions of the measured combustion product by the combustion apparatus in the exhaust stream.

16. The system of claim 1, wherein the combustion analysis circuit is configured to generate air pollution information responsive to (i) a measured combustion product in the exhaust stream, (ii) an emission target value for the measured combustion product, and (iii) correlations between the combustion parameters and emissions of the measured combustion product for the combustion apparatus.

17. The system of claim 1, further comprising:
a non-transitory computer readable storage media configured to store data indicative of cumulative emissions of the measured combustion product by the combustion apparatus and correlations between the combustion parameters and emissions of the measured combustion product for the combustion apparatus.

18. A method comprising:
measuring a combustion product in an exhaust stream generated by a fossil-fueled combustion apparatus;
generating an air pollution information responsive to (i) the measured combustion product and (ii) an emission target for the measured combustion product; and
displaying the air pollution information in a human perceivable format.

19. The method of claim 18, further comprising:
receiving an air quality management selection entered by a human user.

20. The method of claim 19, further comprising:
regulating an aspect of combustion air delivered to the fossil-fueled combustion apparatus in response to the air quality management selection entered by the human user.

21. A system comprising:
a sensor device configured to measure a combustion product in an exhaust stream generated by a fossil-fueled combustion apparatus;
a combustion analysis circuit configured to generate air pollution information responsive to the measured combustion product; and
an output circuit configured to transmit a signal indicative of the air pollution information in a format usable by a computing device.

22. The system of claim 21, wherein the combustion analysis circuit is configured to generate an air pollution information responsive to (i) the measured combustion product and (ii) an emission target for the measured combustion product.

23. The system of claim 21, wherein the computing device includes a consumer-accessible platform.

24. The system of claim 23, wherein the consumer-accessible platform includes a cellular mobile device.

25. The system of claim 23, wherein the consumer-accessible platform includes a processor, display, and user input device.

26. The system of claim 23, wherein the consumer-accessible platform includes a computing device.

27. The system of claim 23, wherein the consumer-accessible platform includes a web enabled device.

28. The system of claim 21, wherein the computing device includes a remote computing device.

29. The system of claim 21, further comprising:
a credit receiver circuit configured to receive from a remote computing device an indication of a credit responsive to the air pollution information.

30. The system of claim 29, wherein the credit includes a regulatory credit.

31. The system of claim 29, wherein the credit includes a financial credit.

32. The system of claim 29, wherein the credit includes a token representing a credit.

33. The system of claim 29, wherein the credit includes a thing of value.

34. The system of claim 21, further comprising:
a selection receiver circuit configured to receive from the consumer-accessible platform an air quality management selection entered by a human user.

35. The system of claim 34, further comprising:
a combustion controller configured to regulate an aspect of combustion of the fossil fuel in response to the air quality management selection entered by the human user.

36. A method comprising:
measuring a combustion product in an exhaust stream generated by a fossil-fueled combustion apparatus;
generating a pollution information responsive to (i) the measured combustion product and (ii) an emission target for the measured combustion product; and
transmitting a signal indicative of the air pollution information in a format usable by a computing device.

37. The system of claim 36, further comprising:
receiving from a consumer-accessible platform an air quality management selection entered by a human user.

38. The system of claim 37, further comprising:
regulating an aspect of combustion of the fossil fuel in response to the air quality management selection entered by the human user.
